(19) United States
(12) Patent Application Publication
(10) Pub. No.: US 2024/0219119 A1
(43) Pub. Date: Jul. 4, 2024

(54) LINTEL BLOCK WITH LOST EDGE

(71) Applicant: SAINT-GOBAIN CERAMICS & PLASTICS, INC., Worcester, MA (US)

(72) Inventors: Olivier CITTI, Villeneuve Iev Avignon (FR); Darren ROGERS, Worcester, MA (US); Kristen E. PAPPACENA, Westborough, MA (US); Gabriel GUENOUN, Boston, MA (US); Eric BUCHOVECKY, Harvard, MA (US)

(21) Appl. No.: 18/542,297

(22) Filed: Dec. 15, 2023

Related U.S. Application Data
(60) Provisional application No. 63/477,480, filed on Dec. 28, 2022.

(51) Int. Cl. F27D 1/04; C03C 25/002

(52) U.S. Cl. CPC F27D 1/04; C03C 25/002

(57) ABSTRACT

A lintel block body having a length (l_{b}), a width (w), and a height (h), wherein the length>width, the width>height, and the length>height, wherein at least one of the corners of the lintel block is a chamfered corner, wherein the lintel block further comprises at least one lost edge adjacent the at least one chamfered corner.

### CROSS-REFERENCE TO RELATED APPLICATION(S)

This application claims priority under 35 U.S.C. § 119(c) to U.S. Provisional Patent Application No. 63/477,480, filed Dec. 28, 2022, by Olivier CITTI et al., entitled “LINTEL BLOCK WITH LOST EDGE,” which is assigned to the current assignee hereof and incorporated herein by reference in its entirety for all purposes.

### BACKGROUND

### Field of the Disclosure

The following is directed to lintel blocks for high-temperature furnaces.

### SUMMARY

According to one aspect, a lintel block a body having a length (l_{b}), a width (w), and a height (h), wherein the length>width, the width>height, and the length>height, wherein at least one of the corners of the lintel block is a chamfered corner, wherein the lintel block further comprises at least one lost edge adjacent the at least one chamfered corner.

### BRIEF DESCRIPTION OF THE DRAWINGS

The present disclosure may be better understood, and its numerous features and advantages made apparent to those skilled in the art by referencing the accompanying drawings.

FIG. 1A includes a side-view illustration of a lintel block according to an embodiment.

FIG. 1B includes a top-view illustration of a lintel block according to an embodiment.

FIG. 2A includes a side-view illustration of a lintel block according to an embodiment.

FIG. 2B includes a top-view illustration of a lintel block according to an embodiment.

FIG. 3A includes a side-view illustration of a lintel block according to an embodiment.

FIG. 3B includes a top-view illustration of a lintel block according to an embodiment.

FIG. 4A includes a side-view illustration of a lintel block according to an embodiment.

FIG. 4B includes a top-view illustration of a lintel block according to an embodiment.

FIG. 5 includes a side-view illustration of a lintel block body and a lost edge according to an embodiment.

FIG. 6 includes a side-view illustration of a furnace according to an embodiment.

FIG. 7A includes a modeled stress/MOR ratio vs. time curve of a standard lintel block and a chamfered lintel block.

FIG. 7B includes a modeled stress/MOR ratio vs. time curve of a standard lintel block and a lintel block with a lost edge.

FIG. 7C includes a modeled stress/MOR ratio vs. time curve of a standard lintel block and a lintel block with an insulating lost edge.

### DETAILED DESCRIPTION

The following is directed to lintel blocks and furnaces that include lintel blocks.

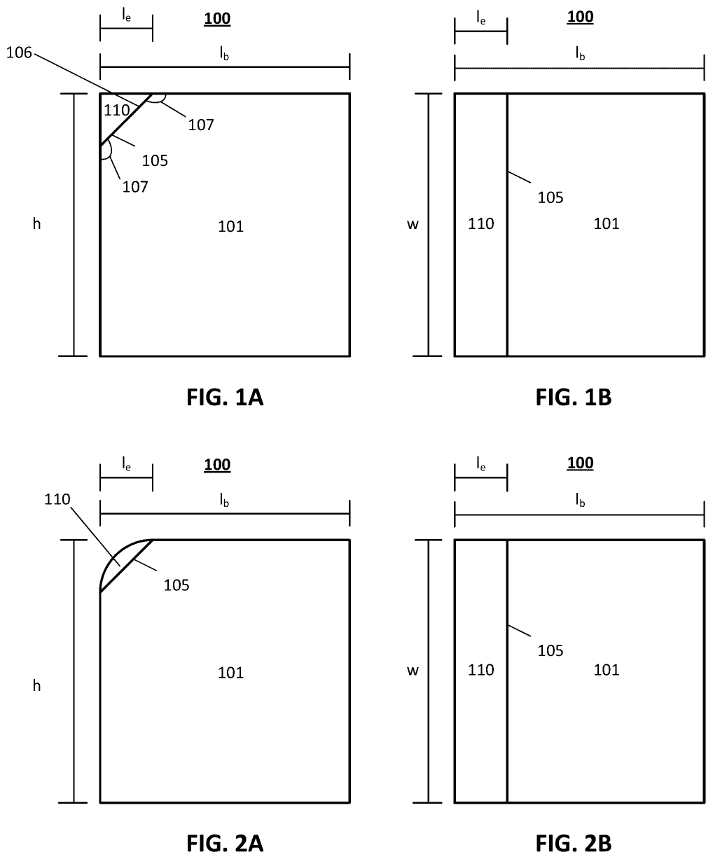

FIGS. 1a and 1b include side-view and top-view illustrations of a lintel block 100 according to an embodiment. The lintel block can have a body 101 having a length (l_{b}), a width (w), and a height (h). The lintel block can include at least one chamfered corner 105. The lintel block can further include a piece of material herein referred to as a “lost edge” 110 adjacent to the chamfered corner 105. The chamfered corner can include a surface 106, and two edges 107 having obtuse angles. FIGS. 2-4 include side-view and top-view illustrations of lintel blocks 100 according to alternative embodiments.

In an embodiment, the side surfaces of the lost edge 110 can be parallel to the side surfaces of the body 101 (e.g., FIGS. 1-3). In an embodiment, the side surfaces of the lost edge 110 can be unparallel to the side surfaces of the body 101 (e.g., FIG. 4). In an embodiment, the lost edge 110 can complete the chamfered corner 105 such that a corner of the lintel block including the chamfered corner 105 and the lost edge 110 comprises 3 flat orthogonal surfaces (e.g., FIG. 1). In an embodiment, the lost edge 110 can complete the chamfered corner 105 such that a corner of the lintel block including the chamfered corner 105 and the lost edge 110 is a rounded corner (e.g., FIG. 2).

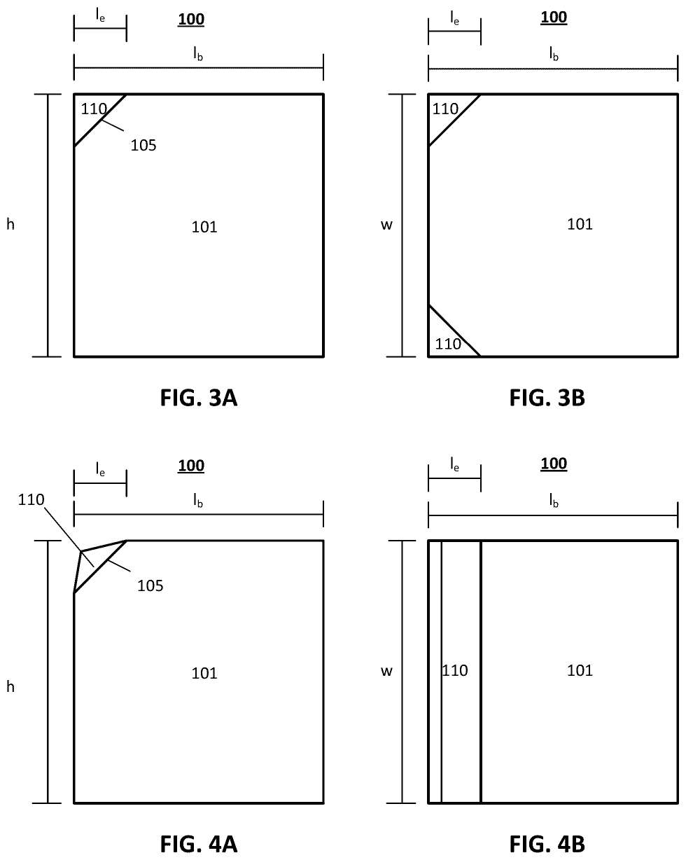

In an embodiment, the lintel block 100 can include more than one chamfered corner 105 and lost edge 110 (e.g., FIG. 3). In embodiments where the lintel block 100 includes more than one chamfered corner 105, at least one chamfered corner 105 can be adjacent to a lost edge 110. In other embodiments where the lintel block 100 includes more than one chamfered corner 105, all chamfered corners 105 can be adjacent to a lost edge 110. In other embodiments where the lintel block 100 includes more than one chamfered corner 105, at least one but not all chamfered corners 105 can be adjacent to a lost edge 110. In an embodiment, the chamfered corner 105 can extend along an entire dimension of the body 101 (e.g., FIGS. 1, 2, and 4). In an embodiment, the chamfered corner 105 can extend along a portion of a dimension of the body 101 (e.g., FIG. 3).

The lintel block body 101 may have a particular length (l_{b}) that may facilitate improved performance and/or manufacturing of the lintel block. In an embodiment, the length of the body (l_{b}) can be at least 400 mm or at least 450 mm or at least 500 mm or at least 550 mm or at least 600 mm or at least 650 mm or at least 700 mm or at least 750 mm or at least 800 mm or at least 850 mm or at least 900 mm. In an embodiment, the length (l_{b}) of the body can be no greater than 1000 mm or no greater than 950 mm or no greater than 900 mm or no greater than 850 mm or no greater than 800 mm or no greater than 750 mm or no greater than 700 mm or no greater than 650 mm or no greater than 600 mm. It will be appreciated that the length (l_{b}) of the body can be between any of the minimum and maximum values noted above, including, for example, but not limited to, at least 400 mm and not greater than 1000 mm or at least 500 mm and not greater than 900 mm.

The lintel block body 101 may have a particular width (w) that may facilitate improved performance and/or manufacturing of the lintel block. In an embodiment, the width (w) can be at least 50 mm or at least 75 mm or at least 100 mm or at least 125 mm or at least 150 mm or at least 175 mm or at least 200 mm or at least 225 mm or at least 250 mm or at least 275 mm or at least 300 mm or at least 325 mm or at least 350 mm or at least 375 mm or at least 400 mm. In an embodiment, the width (w) can be no greater than 500 mm or no greater than 450 mm or no greater than 400 mm or no greater than 350 mm or no greater than 300 mm or no greater than 250 mm or no greater than 200 mm. It will be appreciated that the width (w) can be between any of the minimum and maximum values noted above, including, for example, but not limited to, at least 50 mm and not greater than 500 mm or at least 100 mm and not greater than 450 mm.

The lintel block body 101 may have a particular height (h) that may facilitate improved performance and/or manufacturing of the lintel block. In an embodiment, the height (h) can be at least 50 mm or at least 75 mm or at least 100 mm or at least 125 mm or at least 150 mm or at least 175 mm or at least 200 mm or at least 225 mm or at least 250 mm or at least 275 mm or at least 300 mm or at least 325 mm or at least 350 mm or at least 375 mm or at least 400 mm. In an embodiment, the height (h) can be no greater than 500 mm or no greater than 450 mm or no greater than 400 mm or no greater than 350 mm or no greater than 300 mm or no greater than 250 mm or no greater than 200 mm. It will be appreciated that the height (h) can be between any of the minimum and maximum values noted above, including, for example, but not limited to, at least 50 mm and not greater than 500 mm or at least 100 mm and not greater than 450 mm.

In an embodiment, a lost edge may have a particular length (lₑ) relative to the length of the lintel block body (l_{b}) that may facilitate improved performance of the lintel block. In an embodiment, the ratio lₑ/l_{b} can be at least 0.01 or at least 0.02 or at least 0.03 or at least 0.04 or at least 0.05 or at least 0.06 or at least 0.07 or at least 0.08 or at least 0.09 or at least 0.1 or at least 0.11 or at least 0.12 or at least 0.13 or at least 0.14 or at least 0.15 or at least 0.16 or at least 0.17 or at least 0.18 or at least 0.19 or at least 0.2. In an embodiment, the ratio lₑ/l_{b} can be no greater than 0.25 or no greater than 0.24 or no greater than 0.23 or no greater than 0.22 or no greater than 0.21 or no greater than 0.20 or no greater than 0.19 or no greater than 0.18 or no greater than 0.17 or no greater than 0.16 or no greater than 0.15 or no greater than 0.14 or no greater than 0.13 or no greater than 0.12 or no greater than 0.11 or no greater than 0.10. It will be appreciated that the ratio lₑ/l_{b} can be between any of the minimum and maximum values noted above, including, for example, but not limited to, at least 0.05 and no greater than 0.25 or at least 0.06 and no greater than 0.24.

In an embodiment, the body 101 may include particular materials that may facilitate improved manufacturing and/or performance of the lintel block. In an embodiment, the body 101 can include a refractory material. In an embodiment, the body 101 may include zircon, chromium, or a combination thereof.

In an embodiment, the lost edge 110 may include particular materials that may facilitate improved manufacturing and/or performance of the lintel block. In an embodiment, the lost edge 110 can include a refractory material. In an embodiment, the lost edge 110 may include zircon, chromium, or a combination thereof. In an embodiment, the lost edge 110 may be the same material as the body 101. In an embodiment, the lost edge 101 may consist of a different material than the body. In an embodiment, the lost edge 101 may comprise an insulating material. In an embodiment, the lost edge can be comprised of firebrick. In an embodiment, the lost edge can comprise alumina, mullite, or a combination thereof. In an embodiment, the lost edge can be porous.

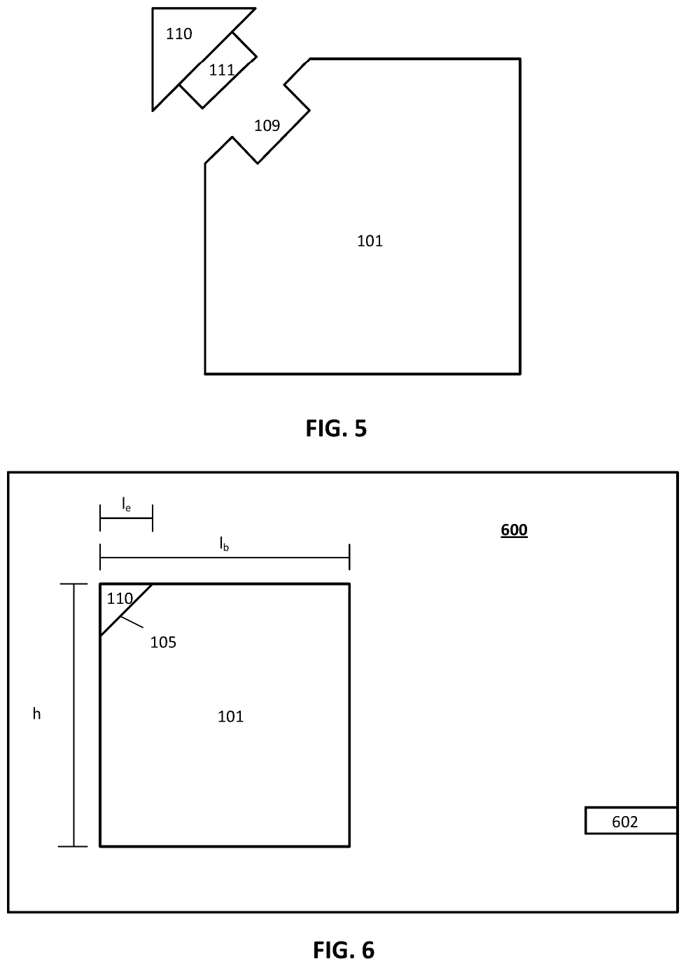

As shown in FIG. 5, in an embodiment, the lost edge 110 can include a protrusion 111 that fits within a recess 109 of the body 101.

As shown in FIG. 6, an embodiment can include a furnace 600 comprising a burner 602 and a lintel block with a body 101 having a chamfered corner 105 and a lost edge 110. As shown in FIG. 6, the chamfered corner and lost edge are opposite the burner. As shown in FIG. 6, the length of the body (l_{b}) is the dimension parallel to the bottom of the furnace 600 and parallel to a ray extending from the burner 602. The length of the lost edge (lₑ) is the dimension of the lost edge parallel to the length of the body (l_{b}). The height of the body (h) is the dimension orthogonal to the bottom of the furnace 600. The width of the body (w) is the dimension parallel to the bottom of the furnace 600 and perpendicular to a ray extending from the burner 602.

An embodiment can include a method of using a furnace with one of the above-described lintel blocks to heat and/or process glass and/or fiberglass.

In an embodiment, a method of using the furnace can include the body of the lintel block having a maximum stress/MOR ratio that may facilitate improved performance of the furnace. In an embodiment, the maximum stress/MOR ratio can be no greater than 5 or no greater than 4.9 or no greater than 4.8 or no greater than 4.7 or no greater than 4.6 or no greater than 4.5 or no greater than 4.4 or no greater than 4.3 or no greater than 4.2 or no greater than 4.1 or no greater than 4.0 or no greater than 3.9 or no greater than 3.8 or no greater than 3.7 or no greater than 3.6 or no greater than 3.5 or no greater than 3.4 or no greater than 3.3 or no greater than 3.2 or no greater than 3.1 or no greater than 3.0 or no greater than 2.9 or no greater than 2.8 or no greater than 2.7 or no greater than 2.6 or no greater than 2.5 or no greater than 2.4 or no greater than 2.3 or no greater than 2.2 or no greater than 2.1 or no greater than 2.0 or no greater than 1.9 or no greater than 1.8 or no greater than 1.7 or no greater than 1.6 or no greater than 1.5 or no greater than 1.4 or no greater than 1.3 or no greater than 1.2 or no greater than 1.1 or no greater than 1.0. In an embodiment, the maximum stress/MOR ratio can be at least 0.1 or at least 0.2 or at least 0.3 or at least 0.4 or at least 0.5 or at least 0.6 or at least 0.7 or at least 0.8 or at least 0.9 or at least 0.1 or at least 0.2 or at least 0.3 or at least 0.4 or at least 0.5 or at least 0.6 or at least 0.7 or at least 0.8 or at least 0.9 or at least 1.0 or at least 1.1 or at least 1.2 or at least 1.3 or at least 1.4 or at least 1.5 or at least 1.6 or at least 1.7 or at least 1.8 or at least 1.9 or at least 1.1 or at least 1.2 or at least 1.3 or at least 1.4 or at least 1.5 or at least 1.6 or at least 1.7 or at least 1.8 or at least 1.9 or at least 2.0. It will be appreciated that the stress/MOR ratio can be between any of the above minimum and maximum values including, but not limited to, at least 0.2 and no greater than 4.0 or at least 1.1 and no greater than 3.9.

### EMBODIMENTS

Embodiment 1. A lintel block comprising:

a body having a length (l_{b}), a width (w), and a height (h) wherein at least one of the corners of the lintel block is a chamfered corner,

wherein the lintel block further comprises at least one lost edge adjacent the at least one chamfered corner.

Embodiment 2. The lintel block of embodiment 1, wherein the chamfered corner comprises a surface and at least 2 edges with obtuse angels.

Embodiment 3. The lintel block of embodiment 1, wherein the chamfered corner extends along an entire dimension of the body.

Embodiment 4. The lintel block of embodiment 1, wherein the chamfered corner extends along a portion of a dimension of the body.

Embodiment 5. The lintel block of embodiment 1, wherein the ratio of the longest dimension of the at least one lost edge (lₑ) to the length of the lintel block body, lₑ/l_{b} is at least 0.01 or at least 0.02 or at least 0.03 or at least 0.04 or at least 0.05 or at least 0.06 or at least 0.07 or at least 0.08 or at least 0.09 or at least 0.1 or at least 0.11 or at least 0.12 or at least 0.13 or at least 0.14 or at least 0.15 or at least 0.16 or at least 0.17 or at least 0.18 or at least 0.19 or at least 0.2.

Embodiment 6. The lintel block of embodiment 1, wherein the ratio lₑ/l_{b} is no greater than 0.25 or no greater than 0.24 or no greater than 0.23 or no greater than 0.22 or no greater than 0.21 or no greater than 0.20 or no greater than 0.19 or no greater than 0.18 or no greater than 0.17 or no greater than 0.16 or no greater than 0.15 or no greater than 0.14 or no greater than 0.13 or no greater than 0.12 or no greater than 0.11 or no greater than 0.10.

Embodiment 7. The lintel block of embodiment 1, wherein the length of the body (l_{b}) is at least 400 mm or at least 450 mm or at least 500 mm or at least 550 mm or at least 600 mm or at least 650 mm or at least 700 mm or at least 750 mm or at least 800 mm or at least 850 mm or at least 900 mm.

Embodiment 8. The lintel block of embodiment 1, wherein the length of the body (l_{b}) is no greater than 1000 mm or no greater than 950 mm or no greater than 900 mm or no greater than 850 mm or no greater than 800 mm or no greater than 750 mm or no greater than 700 mm or no greater than 650 mm or no greater than 600 mm.

Embodiment 9. The lintel block of embodiment 1, wherein the width of the body (w) is at least 50 mm or at least 75 mm or at least 100 mm or at least 125 mm or at least 150 mm or at least 175 mm or at least 200 mm or at least 225 mm or at least 250 mm or at least 275 mm or at least 300 mm or at least 325 mm or at least 350 mm or at least 375 mm or at least 400 mm.

Embodiment 10. The lintel block of embodiment 1, wherein the width of the body (w) is no greater than 500 mm or no greater than 450 mm or no greater than 400 mm or no greater than 350 mm or no greater than 300 mm or no greater than 250 mm or no greater than 200 mm.

Embodiment 11. The lintel block of embodiment 1, wherein the height of the body (h) is at least 50 mm or at least 75 mm or at least 100 mm or at least 125 mm or at least 150 mm or at least 175 mm or at least 200 mm or at least 225 mm or at least 250 mm or at least 275 mm or at least 300 mm or at least 325 mm or at least 350 mm or at least 375 mm or at least 400 mm.

Embodiment 12. The lintel block of embodiment 1, wherein the height of the body (h) is no greater than 500 mm or no greater than 450 mm or no greater than 400 mm or no greater than 350 mm or no greater than 300 mm or no greater than 250 mm or no greater than 200 mm.

Embodiment 13. The lintel block of embodiment 1, wherein the body comprises a refractory material.

Embodiment 14. The lintel block of embodiment 1, wherein the body comprises zircon, chromium, or a combination thereof.

Embodiment 15. The lintel block of embodiment 1, wherein the at least one lost edge comprises a refractory material.

Embodiment 16. The lintel block of embodiment 1, wherein the at least one lost edge consists of the same material as the body.

Embodiment 17. The lintel block of embodiment 1, wherein the at least one lost edge consists of a different material than the body.

Embodiment 18. The lintel block of embodiment 1, wherein the at least one lost edge comprises zircon, chromium, or a combination thereof.

Embodiment 19. The lintel block of embodiment 1, wherein the at least one lost edge comprises a different material than the body.

Embodiment 20. The lintel block of embodiment 1, wherein the at least one lost edge comprises an insulating material.

Embodiment 21. The lintel block of embodiment 1, wherein the at least one lost edge comprises firebrick.

Embodiment 22. The lintel block of embodiment 1, wherein the at least one lost edge comprises alumina, mullite, or a combination thereof.

Embodiment 23. The lintel block of embodiment 1, wherein the at least one lost edge is porous.

Embodiment 24. The lintel block of embodiment 1, wherein the side surfaces of the at least one lost edge are parallel to the side surfaces of the body.

Embodiment 25. The lintel block of embodiment 24, wherein the at least one lost edge completes the chamfered corner such that a corner of the lintel block comprising the chamfered corner and the lost edge comprises 3 flat orthogonal surfaces.

Embodiment 26. The lintel block of embodiment 24, wherein the at least one lost edge completes the chamfered corner such that a corner of the lintel block comprising the chamfered corner and the lost edge is a rounded corner.

Embodiment 27. The lintel block of embodiment 1, wherein the lost edge comprises a protrusion and the chamfered corner comprises a recess, wherein the protrusion fits within the recess.

Embodiment 28. A furnace comprising the lintel block of any of the preceding embodiments and a burner.

Embodiment 29. The furnace of embodiment 28, wherein the chamfered corner of the lintel block is a corner opposite the burner.

Embodiment 30. A method of using the furnace of embodiment 28, wherein the maximum stress/MOR ratio of the body of the lintel block is no greater than 5 or no greater than 4.9 or no greater than 4.8 or no greater than 4.7 or no greater than 4.6 or no greater than 4.5 or no greater than 4.4 or no greater than 4.3 or no greater than 4.2 or no greater than 4.1 or no greater than 4.0 or no greater than 3.9 or no greater than 3.8 or no greater than 3.7 or no greater than 3.6 or no greater than 3.5 or no greater than 3.4 or no greater than 3.3 or no greater than 3.2 or no greater than 3.1 or no greater than 3.0 or no greater than 2.9 or no greater than 2.8 or no greater than 2.7 or no greater than 2.6 or no greater than 2.5 or no greater than 2.4 or no greater than 2.3 or no greater than 2.2 or no greater than 2.1 or no greater than 2.0 or no greater than 1.9 or no greater than 1.8 or no greater than 1.7 or no greater than 1.6 or no greater than 1.5 or no greater than 1.4 or no greater than 1.3 or no greater than 1.2 or no greater than 1.1 or no greater than 1.0.

Embodiment 31. A method of using the furnace of embodiment 28, wherein the maximum stress/MOR ratio of the body of the lintel block is at least 0.1 or at least 0.2 or at least 0.3 or at least 0.4 or at least 0.5 or at least 0.6 or at least 0.7 or at least 0.8 or at least 0.9 or at least 0.1 or at least 0.2 or at least 0.3 or at least 0.4 or at least 0.5 or at least 0.6 or at least 0.7 or at least 0.8 or at least 0.9 or at least 1.0 or at least 1.1 or at least 1.2 or at least 1.3 or at least 1.4 or at least 1.5 or at least 1.6 or at least 1.7 or at least 1.8 or at least 1.9 or at least 1.1 or at least 1.2 or at least 1.3 or at least 1.4 or at least 1.5 or at least 1.6 or at least 1.7 or at least 1.8 or at least 1.9 or at least 2.0.

Embodiment 32. A method of using the furnace of embodiment 28, further comprising heating fiberglass.

### EXAMPLES

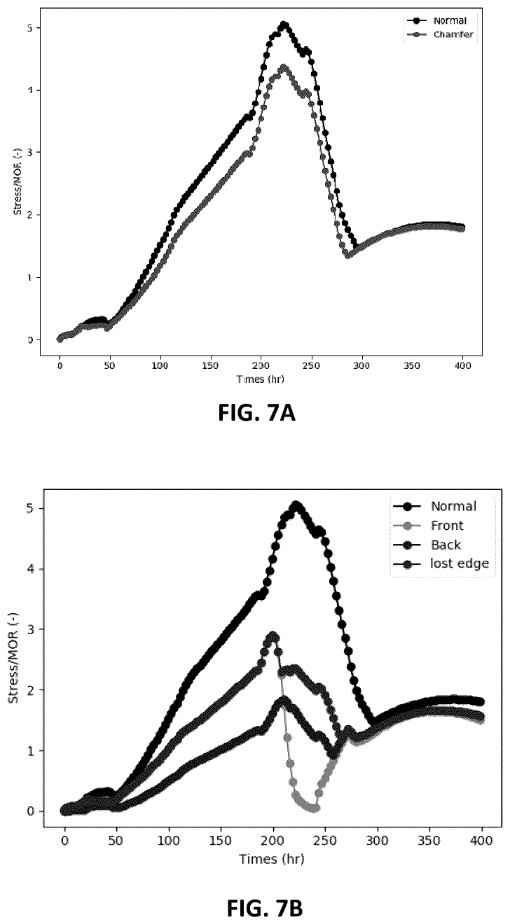

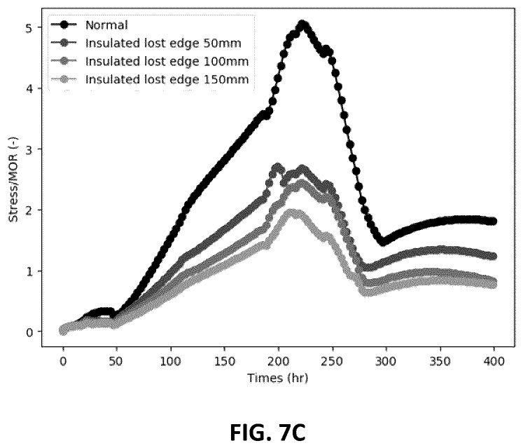

A simulated model was used to predict stress/MOR ratio vs. time curves for various types of lintel blocks. FIG. 7A includes curves for a standard lintel block without chamfered corners and a block with chamfered corners. FIG. 7B includes curves for a standard lintel block and a lintel block including a lost edge of the same material as the lintel block body. FIG. 7C includes curves for a standard lintel block and lintel blocks with insulating lost edges. Maximum stress/MOR ratios can be found below in Table 1.

TABLE 1

| Lintel Block | Maximum Stress/MOR |
|---|---|
| Standard | 5 |
| Chamfer | 4.5 |
| Lost Edge | 2.9 |
| Insulating Lost Edge 50 mm | 2.7 |
| Insulating Lost Edge 100 mm | 2.5 |
| Insulating Lost Edge 150 mm | 2.3 |

While a chamfer resulted in minimal improvement in Stress/MOR ratio, a chamfer with a lost edge results in significant maximum stress/MOR improvement.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure.

This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. A lintel block comprising:
a body having a length (l_{b}), a width (w), and a height (h) wherein at least one of the corners of the lintel block is a chamfered corner,
wherein the lintel block further comprises at least one lost edge adjacent the at least one chamfered corner.

2. The lintel block of claim 1, wherein the chamfered corner comprises a surface and at least 2 edges with obtuse angles.

3. The lintel block of claim 1, wherein the body comprises a refractory material.

4. The lintel block of claim 1, wherein the body comprises zircon, chromium, or a combination thereof.

5. The lintel block of claim 1, wherein the at least one lost edge consists of the same material as the body.

6. The lintel block of claim 1, wherein the at least one lost edge consists of a different material than the body.

7. The lintel block of claim 1, wherein the at least one lost edge comprises zircon, chromium, or a combination thereof.

8. The lintel block of claim 1, wherein the at least one lost edge comprises an insulating material.

9. The lintel block of claim 1, wherein the at least one lost edge comprises firebrick.

10. The lintel block of claim 1, wherein the at least one lost edge comprises alumina, mullite, or a combination thereof.

11. The lintel block of claim 1, wherein the at least one lost edge is porous.

12. The lintel block of claim 1, wherein the side surfaces of the at least one lost edge are parallel to the side surfaces of the body.

13. The lintel block of claim 12, wherein the at least one lost edge completes the chamfered corner such that a corner of the lintel block comprising the chamfered corner and the lost edge comprises 3 flat orthogonal surfaces.

14. The lintel block of claim 12, wherein the at least one lost edge completes the chamfered corner such that a corner of the lintel block comprising the chamfered corner and the lost edge is a rounded corner.

15. The lintel block of claim 1, wherein the lost edge comprises a protrusion and the chamfered corner comprises a recess, wherein the protrusion fits within the recess.

16. A furnace comprising the lintel block of any of the preceding claims and a burner.

17. The furnace of claim 16, wherein the chamfered corner of the lintel block is a corner opposite the burner.

18. A method of using the furnace of claim 16, wherein the maximum stress/MOR ratio of the body of the lintel block is no greater than 5 or no greater than 4.9 or no greater than 4.8 or no greater than 4.7 or no greater than 4.6 or no greater than 4.5 or no greater than 4.4 or no greater than 4.3 or no greater than 4.2 or no greater than 4.1 or no greater than 4.0 or no greater than 3.9 or no greater than 3.8 or no greater than 3.7 or no greater than 3.6 or no greater than 3.5 or no greater than 3.4 or no greater than 3.3 or no greater than 3.2 or no greater than 3.1 or no greater than 3.0 or no greater than 2.9 or no greater than 2.8 or no greater than 2.7 or no greater than 2.6 or no greater than 2.5 or no greater than 2.4 or no greater than 2.3 or no greater than 2.2 or no greater than 2.1 or no greater than 2.0 or no greater than 1.9 or no greater than 1.8 or no greater than 1.7 or no greater than 1.6 or no greater than 1.5 or no greater than 1.4 or no greater than 1.3 or no greater than 1.2 or no greater than 1.1 or no greater than 1.0.

19. A method of using the furnace of claim 16, wherein the maximum stress/MOR ratio of the body of the lintel block is at least 0.1 or at least 0.2 or at least 0.3 or at least 0.4 or at least 0.5 or at least 0.6 or at least 0.7 or at least 0.8 or at least 0.9 or at least 0.1 or at least 0.2 or at least 0.3 or at least 0.4 or at least 0.5 or at least 0.6 or at least 0.7 or at least 0.8 or at least 0.9 or at least 1.0 or at least 1.1 or at least 1.2 or at least 1.3 or at least 1.4 or at least 1.5 or at least 1.6 or at least 1.7 or at least 1.8 or at least 1.9 or at least 1.1 or at least 1.2 or at least 1.3 or at least 1.4 or at least 1.5 or at least 1.6 or at least 1.7 or at least 1.8 or at least 1.9 or at least 2.0.

20. A method of using the furnace of claim 16, further comprising heating fiberglass.
